(19) United States
(12) Patent Application Publication
(10) Pub. No.: US 2024/0009620 A1
(43) Pub. Date: Jan. 11, 2024

(54) VALUABLE GAS RECOVERY APPARATUS

(71) Applicant: LDetek Inc., Thetford Mines (CA)

(72) Inventors: Dany Gagne, Thetford Mines (CA); Louis Paradis, Thetford Mines (CA)

(21) Appl. No.: 18/347,216

(22) Filed: Jul. 5, 2023

Related U.S. Application Data
(60) Provisional application No. 63/367,680, filed on Jul. 5, 2022.

(51) Int. Cl. B01D 53/86; F17C 7/00; C01B 23/00; G01N 31/10

(52) U.S. Cl. CPC B01D 53/86; F17C 7/00; C01B 23/0094; G01N 31/10; F17C 2201/0185; F17C 2227/0135; F17C 2221/017; F17C 2205/0323; F17C 2250/0447; F17C 2205/0338; F17C 2260/056; C01B 2210/001; C01B 2210/0003; C01B 2210/0031

(57) ABSTRACT

An apparatus for collecting helium gas includes: a first receptacle having a first flexible membrane for receiving a gas containing helium, the first receptacle being selectively couplable to an inlet of the apparatus; a second receptacle having a second flexible membrane for receiving the gas containing helium, the second receptacle being selectively couplable to the inlet of the apparatus; a pump having an inlet selectively couplable to an outlet of the first receptacle and selectively couplable to an outlet of the second receptacle; a purifier having an inlet couplable to an outlet of the pump; and an outlet of the apparatus couplable to an outlet of the purifier. A method of collecting and reusing helium gas is also described. Other valuable and/or rare gases may be recovered and reused.

### CROSS-REFERENCE TO RELATED APPLICATION

This application claims the benefit of U.S. Provisional patent application Ser. No. 63/367,680, filed on Jul. 5, 2022.

### TECHNICAL FIELD

The invention relates to a recovery apparatus for a valuable gas, such as a helium recovery apparatus, and in particular to a helium recovery apparatus for a gas chromatograph.

### BACKGROUND

Due to its unique properties, helium has a variety of practical applications. In many of these applications, helium is not easily replaceable by any other available substance. One such use is as an inert carrier gas for gas chromatographs (GC). A GC typically uses between 10-1000 standard cubic centimeters per minute (SCCM) of helium.

Helium cannot be manufactured. Some helium can be collected from natural deposits that are trapped by underground rock formations. However, once the helium is released into Earth's atmosphere, it can no longer be recovered. Due to the small size of the helium molecule, it eventually escapes the atmosphere and is lost. As a result, helium is considered a scarce and non-renewable resource, and is costly to replace. Many users of helium attempt to recover and reuse as much of the helium as they can, to avoid having to purchase replacement gas and to preserve the global supply.

Depending on the application, recovering used helium can pose some challenges. For example, in gas chromatography, the helium is used as an inert carrier gas for the sample being analyzed. As a result, the helium becomes contaminated with other substances, and is sometimes vented into the atmosphere because it is not considered reusable. Collecting the used helium from a GC instead of venting it also poses challenges, because fluctuations in the output pressure can affect the equilibrium of the mobile phase, and significant fluctuations in the output pressure can damage the apparatus.

Some attempts to collect used helium from a GC use a flexible membrane to collect the gas at a consistent pressure that does not affect the GC, approximately atmospheric pressure. However, the collected gas must then be removed from the flexible membrane and pressurized to the working pressure of the GC, which could be 50-120 PSIG. This process alters the pressure inside the flexible membrane, which in turn affects the pressure at the output of the GC. One method of mitigating the effect on the GC is to vent the gas from the GC to the atmosphere while the collected gas is being pumped out of the flexible membrane. This results in some wasted helium.

There is a desire for a method of collecting and reusing helium that has been used in a GC, which reduces the loss of helium and does not damage the GC.

### SUMMARY

It is an object of the present invention to ameliorate at least one drawback of the prior art.

It is an object of the present invention to collect, purify, and reuse a valuable gas, such as helium, for example from a GC in a manner that reduces the loss of helium and does not affect the output gas pressure of the GC.

According to a first broad aspect, an apparatus for collecting a valuable gas comprises: a first receptacle having a first flexible membrane for receiving a gas containing the valuable gas, the first receptacle being selectively couplable to an inlet of the apparatus; at least a second receptacle having a second flexible membrane for receiving the gas containing the valuable gas, the second receptacle being selectively couplable to the inlet of the apparatus; a pump having an inlet selectively couplable to an outlet of the first receptacle and selectively couplable to an outlet of the second receptacle; a purifier having an inlet couplable to an outlet of the pump; and an outlet of the apparatus couplable to an outlet of the purifier.

Optionally, in any of the previous aspects, the first receptacle is selectively couplable to the inlet of the apparatus via a first valve; the second receptacle is selectively couplable to the inlet of the apparatus via a second valve; the inlet of the pump is selectively couplable to the outlet of the first receptacle via a third valve; and the inlet of the pump is selectively couplable to the second receptacle by a fourth valve.

Optionally, in any of the previous aspects, the apparatus includes a controller configured to: couple the first receptacle to the inlet of the apparatus when the second receptacle is coupled to the inlet of the pump; and couple the second receptacle to the inlet of the apparatus when the first receptacle is coupled to the inlet of the pump.

Optionally, in any of the previous aspects, the apparatus includes a detector coupled between the outlet of the purifier and the outlet of the apparatus, for detecting impurities in a valuable gas output by the purifier.

Optionally, in any of the previous aspects, the apparatus includes a reserve supply of pressurized valuable gas connectable to the outlet of the apparatus. The apparatus is configured to connect the reserve supply of pressurized valuable gas to the outlet of the apparatus in response to detecting a fault in the valuable gas output by the purifier.

Optionally, in any of the previous aspects, the fault is one of: insufficient pressure in the valuable gas output by the purifier; or an impurity detected by the detector.

Optionally, in any of the previous aspects, the inlet of the apparatus is connectable to an outlet of a gas chromatograph; and the outlet of the apparatus is connectable to a carrier gas inlet of the gas chromatograph.

Optionally, in any of the previous aspects, the apparatus includes a pressure regulator coupled to the outlet of the apparatus, for regulating a pressure of a valuable gas output by the apparatus.

Optionally, in any of the previous aspects, the valuable gas is a noble gas. Optionally, the noble gas is helium.

According to a second broad aspect, a method for collecting and reusing a valuable gas comprises: receiving a gas containing the valuable gas from an inlet by an apparatus having first and second flexible membranes; expelling the gas from the first and second flexible membranes to a pump, such that the first flexible membrane receives the gas from the inlet while the second flexible membrane expels the gas, and such that the second flexible membrane receives the gas from the inlet while the first flexible membrane expels the gas; using the pump, pumping the gas to produce a pressurized gas; purifying the pressurized gas to produce the valuable gas; and providing the valuable gas to an outlet of the apparatus.

Optionally, in any of the previous aspects, the method includes: detecting, by a detector, the purity of the produced valuable gas.

Optionally, in any of the previous aspects, the method includes: in response to detecting an impurity in the produced valuable gas, decoupling the produced valuable gas from the outlet of the apparatus and coupling a secondary supply of valuable gas to the outlet of the apparatus.

Optionally, in any of the previous aspects, the method includes: in response to detecting an insufficient pressure in the produced valuable gas, coupling a secondary supply of valuable gas to the outlet of the apparatus.

Optionally, in any of the previous aspects, the valuable gas is a noble gas. Optionally, the noble gas is helium.

Optionally, in any of the previous aspects, receiving the gas containing the valuable gas from the inlet comprises receiving a gas containing helium from a gas chromatograph; and providing the valuable gas to the outlet of the apparatus comprises providing helium to a carrier gas inlet of the gas chromatograph.

According to another broad aspect, the use of a plurality of receptacles, each receptacle comprising a flexible membrane and each receptacle being selectively couplable to an inlet valve and to an outlet valve, to collect an output gas from an output gas outlet at a substantially constant pressure is provided. Optionally, the output gas comprises a noble gas. Optionally, the noble gas is helium.

### BRIEF DESCRIPTION OF THE DRAWINGS

Having thus generally described the nature of the invention, reference will now be made to the accompanying drawings, showing by way of illustration example embodiments thereof and in which:

FIG. 1 is a perspective view of a helium recovery apparatus according to an embodiment;

FIG. 2 is a schematic view of the helium recovery apparatus of FIG. 1; and

FIG. 3 is a flowchart of a method of collecting and reusing helium gas.

### DETAILED DESCRIPTION

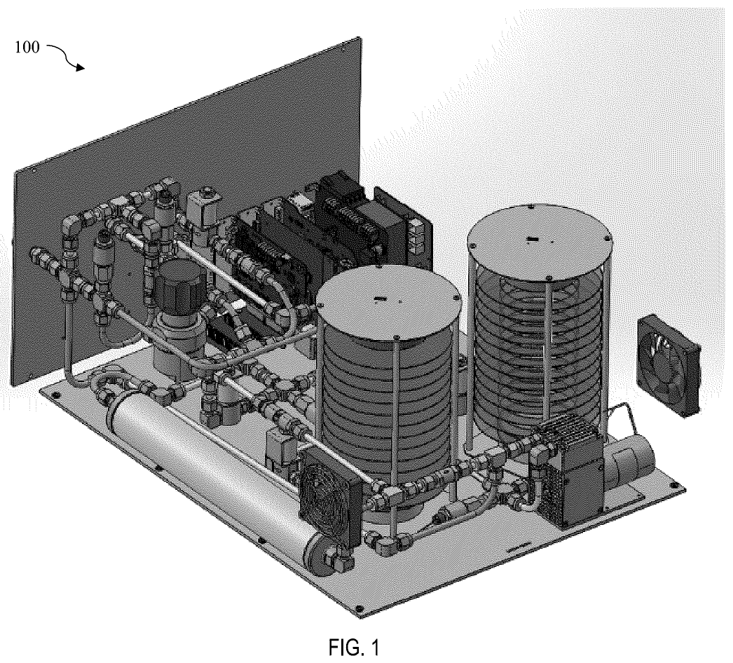

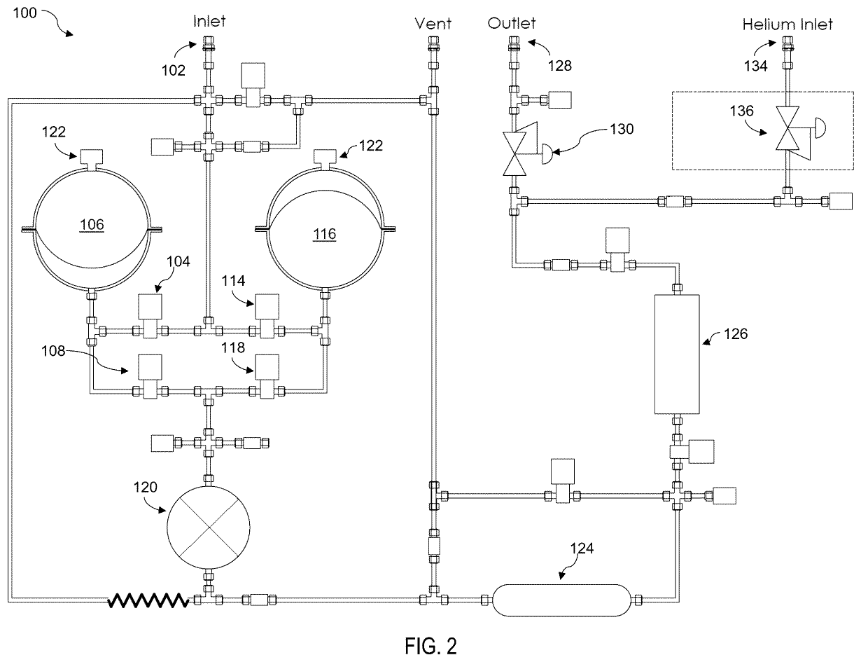

Referring to FIGS. 1 and 2, a helium recovery apparatus 100 according to an embodiment will be described.

The apparatus 100 receives used helium gas from a gas chromatograph (GC) via the inlet 102. The gas is directed via inlet valves 104, 114 to one of two collection chambers 106, 116. Each collection chamber 106, 116 has a flexible membrane or other suitable structure to permit the collection of gas at a consistent pressure, for example an ambient pressure of approximately one atmosphere. In this manner, the used helium can be collected at a pressure that does not damage the GC. Each collection chamber 106, 116, is connectable via one of outlet valves 108, 118, to a high pressure pump or compressor 120.

The valves 104, 114, 108, 118 can be controlled, for example using a microcontroller or other controller (not shown), in such a way that only one of the collection chambers 106, 116 is connected to the inlet 102 at a time, via its respective inlet valve 104, 114. While one of the collection chambers 106, 116 is connected to the inlet 102, the other collection chamber 106, 116 can be connected to the pump 120 via its respective outlet valve 108, 118. In this manner, the collection chamber 106 can be emptied by the pump 120 while the collection chamber 116 is collecting helium gas, and vice versa. Each collection chamber 106, 116 may be used in turn to collect used helium via the inlet 102, and then emptied by the pump 120 while the other collection chamber 106, 116 is isolated from the pump 120 and collecting used helium via the inlet 102. Because each collection chamber 106, 116 is isolated from the pump 120 by its respective outlet valve 108, 118 while it is collecting gas, and each collection chamber 106, 116 is isolated from the inlet 102 while it is being emptied, the collection chambers 106, 116 are able to collect used helium gas and be emptied while keeping the inlet 102 at a constant pressure, and without the need to vent any helium gas during normal operation. It will be understood that more than two collection chambers may be present in an apparatus according to the present invention. For example, some processes, such as variable helium flowrate processes, may occasionally provide a helium volume exceeding the volume of one collection chamber to the inlet 102 while a collection chamber is emptying. Accordingly, additional collection chambers may be provided to minimize venting. Furthermore, it will be understood that additional collection chambers may be beneficial as a failsafe and/or a process redundancy feature to increase stress resilience of the apparatus 100.

The collection chambers 106, 116 may each be equipped with sensors 122 that indicate to the controller that a threshold gas volume has been reached. When the threshold gas volume has been reached, for example in the collection chamber 106, the collection chamber 106 is isolated from the inlet 102 via the inlet valve 104, and connected to the pump 120 via the outlet valve 108, so that the collection chamber 106 can be emptied without affecting the pressure at the input 102. At the same time, the collection chamber 116 is connected to the inlet 102 via the inlet valve 114 and isolated from the pump 120 via the outlet valve 118, so that the apparatus 100 as a whole can continue to collect used helium without interruption.

The pump 120 pulls the used helium from the chambers 106, 116 as described above, and compresses the used helium to at least a pressure suitable for use by a GC, which is typically between 50-120 PSIG. The pressurized helium gas is stored in the expansion chamber 124.

The pressurized helium gas is then passed through a purifier 126 to remove any contaminants. The purifier may contain one or more heated catalysts containing metals, such as zirconium, vanadium, palladium, copper, and iron, that are capable of absorbing the contaminants. In one embodiment, a first catalyst bed is heated to about 450° C. (about 840° F.) and a second catalyst bed is heated to about 250° C. (about 480° F.). The purifier is preferably able to output helium with a purity of 99.999999%, which is suitable to use as the input to a GC. One suitable purifier is the LDP 1000™ series, available from LDetek Inc.

The output of the purifier 126 may be connected to the outlet 128 of the apparatus 100, which can be connected to the helium input of a GC. However, some additional modules may be provided for improved performance of the GC.

An output pressure regulator 130 is preferably provided to regulate the pressure of helium at the outlet 128 to ensure that the pressure is suitable for the particular GC apparatus that is connected to the outlet 110.

A purity monitoring device, such as a micro plasma detector 132, is preferably connected to the outlet 128. The micro plasma detector 132 monitors the purity of the helium at the outlet 128, and ensures that the GC receives sufficiently pure helium. In one embodiment, the micro plasma detector 132 detects at least nitrogen and moisture, which are present in the surrounding air, and which may be the earliest indicators that the purifier 126 is not adequately performing its function. If impurities are detected, the micro plasma detector 132 may send a signal to the microcontroller to stop the gas flow from the purifier 126 to the outlet 128. Examples of suitable purity monitoring devices are the PlasmaDetek™ 2 and PlasmaDetek™ 3, available from LDetek Inc.

An external helium supply (not shown) may be connected to the helium inlet 134. The external helium supply is a reserve helium supply that may be used as needed, for example to initially feed the system, to supplement the output of the purifier in the event that the helium pressure downstream of the purifier 126 is insufficient for the operation of the GC, in the event of some loss of helium during the GC process, or as a primary supply to the GC if impurities are detected in the output of the purifier 126 by the micro plasma detector 132. A pressure regulator 136 is provided for the helium inlet 134, because typical external helium supplies may have a high pressure, such as 3000 PSIG. The helium output from the pressure regulator 136 is then passed through the outlet pressure regulator, 130 to ensure that the pressure is appropriate for the GC, as well as the micro plasma detector 132, to ensure that the helium supply is sufficiently pure for the GC.

It is contemplated that the apparatus 100 may include additional features other than the ones described above. For example, additional check valves, relief valves, pressure sensors, and/or vents may be provided as needed or desired to control or monitor the flow of gas through the apparatus 100.

It is contemplated that the apparatus 100 may be adapted for use with other gases, or for helium used by other types of equipment, for example by using an appropriate purifier and purity monitoring device, and regulating the output pressure accordingly. An apparatus 100 as described above may be particularly useful when the equipment from which the gas is being recovered is sensitive to variations in gas pressure at its output.

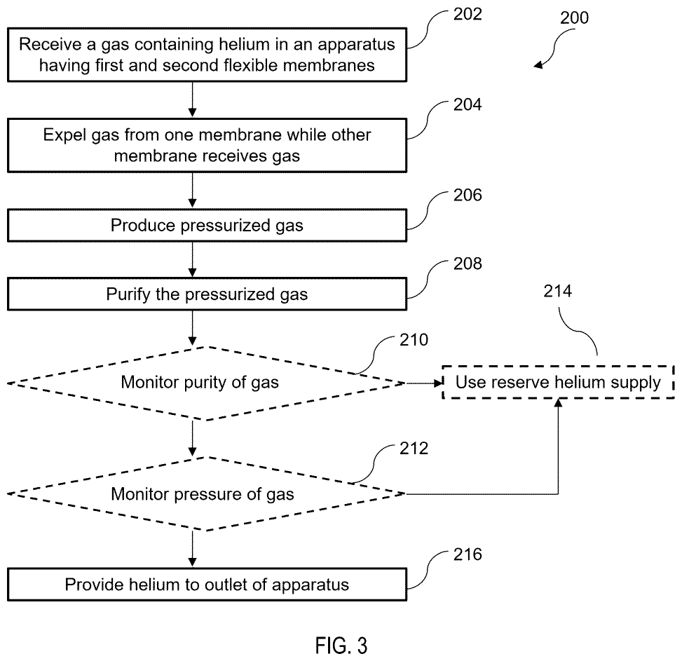

Referring now to FIG. 3, a method 200 of collecting and reusing helium gas will be described. The method may be performed by an apparatus such as the apparatus 100 described above. It will be understood that the method 200 and the apparatus 100 may be used to collect and reuse other gases, for example valuable gases. For example, the methods and apparatuses of the present invention may be used to collect and reuse hydrogen, deuterium and deuterium-containing compounds, tritium and tritium-containing compounds, noble gases, and other gases which may be difficult or expensive to isolate, purify or manufacture.

At step 202, a gas containing helium is received in an apparatus having first and second flexible membranes. The gas may be received from a gas chromatograph. A system of valves is used to direct the gas into either the first or the second flexible membrane.

At step 204, the gas is expelled from each flexible membrane while the other flexible membrane is connected to the input to receive gas. A pump or compressor may be used to draw the gas from the flexible membrane. A system of valves is used to ensure that one of the flexible membranes is connected to the pump while the other flexible membrane is connected to the gas inlet of the apparatus, to ensure a consistent gas pressure at the gas inlet of the apparatus.

At step 206, the pump pressurizes the gas, to produce a pressurized gas. As described above, the gas may be pressurized to a suitable pressure for use by a gas chromatograph, which may typically be in the range of 50-120 PSIG. The pressurized gas may be stored in an expansion chamber.

At step 208, the pressurized gas is purified to remove any contaminants and produce high purity helium suitable for use in a gas chromatograph.

At step 210, the purity of the helium gas is optionally monitored to ensure that it is suitable for use in a gas chromatograph. If the gas contains an unacceptable level of impurities, the apparatus may decouple the flow of gas from the output of the apparatus, and instead connect a secondary supply of helium to the output of the apparatus at step 214.

At step 212, the pressure of the helium gas is optionally monitored to ensure that it is suitable for use in a gas chromatograph. If the gas has insufficient pressure, the apparatus may connect a secondary supply of helium to the output of the apparatus at step 214, for example to supplement the pressure of the produced helium gas.

At step 216, the produced helium gas is provided to an outlet of the apparatus, which may be coupled to the carrier gas inlet of a gas chromatograph.

The embodiments described above are intended to be examples only and do not limit the scope of the invention. Other useful embodiments or variations may be apparent to persons of skill practicing the invention without departing from the present teachings.

1. An apparatus for collecting a valuable gas, comprising:
a first receptacle having a first flexible membrane for receiving a gas containing the valuable gas, the first receptacle being selectively couplable to an inlet of the apparatus;
at least a second receptacle having a second flexible membrane for receiving the gas containing the valuable gas, the second receptacle being selectively couplable to the inlet of the apparatus;
a pump having an inlet selectively couplable to an outlet of the first receptacle and selectively couplable to an outlet of the second receptacle;
a purifier having an inlet couplable to an outlet of the pump; and
an outlet of the apparatus couplable to an outlet of the purifier.

2. The apparatus of claim 1, wherein the valuable gas is a noble gas.

3. The apparatus of claim 1, wherein the valuable gas is helium.

4. The apparatus of claim 1, wherein:
the first receptacle is selectively couplable to the inlet of the apparatus via a first valve;
the second receptacle is selectively couplable to the inlet of the apparatus via a second valve;
the inlet of the pump is selectively couplable to the outlet of the first receptacle via a third valve; and
the inlet of the pump is selectively couplable to the outlet of the second receptacle via a fourth valve.

5. The apparatus of claim 1, further comprising a controller configured to:
couple the first receptacle to the inlet of the apparatus when the second receptacle is coupled to the inlet of the pump; and
couple the second receptacle to the inlet of the apparatus when the first receptacle is coupled to the inlet of the pump.

6. The apparatus of claim 1, further comprising:
a detector coupled between the outlet of the purifier and the outlet of the apparatus, for detecting impurities in a valuable gas output by the purifier.

7. The apparatus of claim 6, further comprising:
a reserve supply of pressurized valuable gas connectable to the outlet of the apparatus;
the apparatus being configured to connect the reserve supply of pressurized valuable gas to the outlet of the apparatus in response to detecting a fault in the valuable gas output by the purifier.

8. The apparatus of claim 7, wherein the fault is one of:
an insufficient pressure in the valuable gas output by the purifier; or
an impurity detected by the detector.

9. The apparatus of claim 1, wherein:
the inlet of the apparatus is connectable to an outlet of a gas chromatograph; and
the outlet of the apparatus is connectable to a carrier gas inlet of the gas chromatograph.

10. The apparatus of claim 1, further comprising a pressure regulator coupled to the outlet of the apparatus, for regulating a pressure of a valuable gas output by the apparatus.

11. The apparatus of claim 1, further comprising at least one additional receptacle, each additional receptacle having an additional flexible membrane for receiving the gas containing the valuable gas, each of the at least one additional receptacle being selectively couplable to the inlet of the apparatus, wherein the pump inlet is selectively couplable to each of an outlet of each of the at least one additional receptacle.

12. A gas chromatograph comprising the apparatus of claim 1.

13. A method for collecting and reusing a valuable gas, comprising:
receiving a gas from an inlet by an apparatus having first and second flexible membranes;
expelling the gas from the first and second flexible membranes to a pump, such that the first flexible membrane receives the gas from the inlet while the second flexible membrane expels the gas, and such that the second flexible membrane receives the gas from the inlet while the first flexible membrane expels the gas;
using the pump, pumping the gas to produce a pressurized gas;
purifying the pressurized gas to produce the valuable gas; and
providing the valuable gas to an outlet of the apparatus.

14. The method of claim 13, wherein the valuable gas is helium.

15. The method of claim 13, further comprising:
detecting, by a detector, the purity of the produced valuable gas.

16. The method of claim 15, further comprising:
in response to detecting an impurity in the produced valuable gas, decoupling the produced valuable gas from the outlet of the apparatus and coupling a secondary supply of valuable gas to the outlet of the apparatus.

17. The method of claim 13, further comprising:
in response to detecting an insufficient pressure in the produced valuable gas, coupling a secondary supply of valuable gas to the outlet of the apparatus.

18. The method of claim 13, wherein:
receiving the gas containing the valuable gas from the inlet comprises receiving a gas containing helium from a gas chromatograph; and
providing the valuable gas to the outlet of the apparatus comprises providing helium to a carrier gas inlet of the gas chromatograph.
